(19) United States
(12) Patent Application Publication
(10) Pub. No.: US 2014/0217859 A1
(43) Pub. Date: Aug. 7, 2014

(54) PERMANENT MAGNET TYPE ROTATING ELECTRICAL MACHINE AND VEHICLE USING THE ELECTRICAL MACHINE

(71) Applicant: Hitachi Automotive Systems, Ltd., Hitachinaka-shi, Ibaraki (JP)

(72) Inventors: Yasuyuki Saito, Hitachinaka (JP); Tomoaki Kaimori, Hitachinaka (JP); Taisuke Ikeda, Hitachinaka (JP); Manabu Oshida, Hitachinaka (JP)

(73) Assignee: Hitachi Automotive Systems, Ltd, Hitachinaka-shi, Ibaraki (JP)

(21) Appl. No.: 14/346,915

(22) PCT Filed: Oct. 3, 2012
(86) PCT No.: PCT/JP2012/075671

§ 371 Date: Mar. 24, 2014

(30) Foreign Application Priority Data
Oct. 4, 2011 (JP) 2011-220056

(51) Int. Cl. H02K 1/27

(52) U.S. Cl. CPC H02K 1/2706
USPC 310/68 D; 310/156.12

(57) ABSTRACT

Permanent magnet type rotating electrical machine with rotor core including a plurality of magnet insertion holes, each having a substantially rectangular cross section, for each magnetic pole. A nonmagnetic section is formed at both ends of the magnet insertion hole in a circumferential direction. Between adjacent magnet insertion holes, a bridge section mechanically connects a rotor core section on the outside of the magnet insertion hole and a rotor core section on the inside thereof. Clearance sections for a corner of the permanent magnet inserted in magnet insertion hole projected in the circumferential direction and a radial direction of the rotor are provided at a corner between surface of the magnet insertion hole on the bridge section and a surface on the outside of the rotor and at a corner between surface of the magnet insertion hole on the bridge section and a surface on the inside of the rotor.

### TECHNICAL FIELD

The present invention relates to a permanent magnet type rotating electrical machine and a vehicle using the permanent magnet type rotating electrical machine.

### BACKGROUND ART

A permanent magnet type rotating electrical machine that is used to drive an electric drive vehicle such as a hybrid vehicle (HV) and an electric vehicle (EV) has been demanded to achieve high-speed rotation. Particularly, the permanent magnet type rotating electrical machine that is capable of outputting high power in a high-speed rotation range has been demanded. For this reason, as the conventional permanent magnet type rotating electrical machine, a permanent magnet type rotating electrical machine of embedded type having an auxiliary salient pole has widely been used that is capable of field weakening during the high-speed rotation and utilizing reluctance torque. For example, PTL 1 describes a structure of the permanent magnet type rotating electrical machine that can output high power and mechanically rotate at a high speed.

A rotor for the permanent magnet type rotating electrical machine that can withstand such high-speed rotation is provided with a magnet insertion hole for each magnetic pole, the magnet insertion hole having a substantially rectangular cross section and a long permanent magnet with a rectangular cross section being inserted therein. When the permanent magnet is inserted in the magnet insertion hole and the rotating electrical machine is driven to cause rotation of the rotor, large stress particularly acts on a corner of the magnet insertion hole that contacts a corner of the permanent magnet by a centrifugal force. When the stress is large, the stress may lead to breakage of the magnet or breakage of the rotor.

PTL 2 describes a rotor having a groove for a magnet in which a permanent magnet is inserted and that is formed with an outwardly arcuate bulge at a corner thereof so that a corner of the permanent magnet is prevented from contacting the corner of the groove for the magnet.

PTL 3 describes a magnet type rotating electrical machine that is provided with: a plurality of magnet slots, in each of which a permanent magnet is inserted, for each magnetic pole; a narrow-width core section and a wide-width core section in a rotor core portion between the adjacent magnet slots in a same magnetic pole of the rotor; and an arc section such that a width of the narrow-width core section is continuously changed.

### CITATION LIST

### Patent Literature

[PTL 1] JP-A-2006-187189
[PTL 2] JP-A-9-294344
[PTL 3] JP-A-2002-281700

### SUMMARY OF INVENTION

### Technical Problem

In the rotor for the permanent magnet type rotating electrical machine described in PTL 1 and PTL 3, a bridge section (the core section in the magnet slot) is provided between two adjacent ones of the plural magnet insertion holes that are provided for each magnetic pole. The corner on the bridge section side of the magnet insertion hole has not been designed in consideration of stress in a radial direction and stress in a circumferential direction of the rotor as well as of magnetic saturation in the bridge section. Thus, the above-mentioned permanent magnet type rotating electrical machine cannot sufficiently handle the high-speed rotation.

### Solution to Problem

According to a first aspect of the invention, the permanent magnet type rotating electrical machine has a stator and a rotor that is disposed correspondingly to the stator via a gap. The rotor includes: a rotor core including plural magnet insertion holes, each of which has a substantially rectangular cross section, for each magnetic pole; and a permanent magnet inserted in each of the magnet insertion holes. A nonmagnetic section is formed at both ends in a circumferential direction of each of the plural magnet insertion holes, which are provided for the each magnet pole of the rotor. A bridge section for mechanically connecting a rotor core section on the outside of the magnet insertion hole to a rotor core section on the inside of the magnet insertion hole is provided between the adjacent ones of the plural magnet insertion holes. Clearance sections that are respectively projected in the circumferential direction and a radial direction of the rotor are provided at a first corner that is a corner between a surface of the magnet insertion hole on the bridge section side and a surface of the magnet insertion hole on the outside of the rotor and at a second corner that is a corner between a surface of the magnet insertion hole on the bridge section side and a surface of the magnet insertion hole on the inside of the rotor such that a corner of the long permanent magnet with a rectangular cross section, which is inserted in the magnet insertion hole, does not contact the surfaces of the magnet insertion hole on the bridge section side, on the outside of the rotor, and on the inside of the rotor. The clearance section for the surface of the magnet insertion hole on the bridge section side is formed to reduce size thereof at the corner of the permanent magnet, while the clearance sections for the surface of the magnet insertion hole on the outside of the rotor and for the surface of the magnet insertion hole on the inside of the rotor are each formed to reduce the size thereof at the corner of the permanent magnet.

According to a second aspect of the invention, when a minimum width of the rotor core on an outer peripheral side of the nonmagnetic section is set to W1, a minimum width of the bridge section is set to W2, and a minimum width of a core on the outer peripheral side of the rotor at the first corner of the magnet insertion hole is set to W3 in the permanent magnet type rotating electrical machine of the first aspect, it is preferred that W2<W1<W3 is established.

According to a third aspect of the invention, when a maximum width of the bridge section is set to W4 in the permanent magnet type rotating electrical machine of the second aspect, it is preferred that W2<W4<W1<W3 is established.

According to a fourth aspect of the invention, the corner of the permanent magnet is chamfered in a curved shape or to have a planar surface in the permanent magnet type rotating electrical machine of any one of the first to third aspects. Each of the first corner of the magnet insertion hole and the second corner of the magnet insertion hole includes a curved surface that is positioned close to the corner of the permanent magnet, the planar surface that is connected to the curved surface and forms the circumferential clearance section, and a planar surface that is connected to the curved surface and forms the radial clearance section.

According to a fifth aspect of the invention, the corner of the permanent magnet is chamfered in the curved shape or to have the planar surface in the permanent magnet type rotating electrical machine of any one of the first to third aspects. Each of the first corner of the magnet insertion hole and the second corner of the magnet insertion hole preferably includes a planar surface that is positioned close to the corner of the permanent magnet, a curved surface that is connected to the planar surface and forms the circumferential clearance section, and a curved surface that is connected to the planar surface and forms the radial clearance section.

According to a sixth aspect of the invention, in the permanent magnet type rotating electrical machine according to the fourth or fifth aspect, curvature of the curved surface is smaller than curvature of chamfering of the curved shape of the permanent magnet.

According to a seventh aspect of the invention, an electric driving device for a vehicle includes: the permanent magnet type rotating electrical machine according to any one of the first to sixth aspects; and a power converter for supplying power to drive the rotating electrical machine.

According to an eighth aspect of the invention, a vehicle includes the electric driving device for a vehicle according to the seventh aspect.

### Advantageous Effects of Invention

According to the invention, it is possible to produce a permanent magnet type rotating electrical machine that can withstand high-speed rotation and output high power.

### BRIEF DESCRIPTION OF DRAWINGS

FIG. 1 is a schematic configuration diagram of a hybrid electric vehicle in which a rotating electrical machine according to the invention is mounted.

FIG. 2 is a schematic configuration diagram of a circuit in a power converter 600 that is used to drive the rotating electrical machine according to the invention.

FIG. 3 is a cross-sectional view of a first embodiment of the rotating electrical machine according to the invention.

FIG. 4 is a view for showing cross sections of a stator 230 and a rotor 250 of the rotating electrical machine shown in FIG. 3.

FIG. 5 is a view for explaining reluctance torque.

FIG. 6 is an enlarged view of the stator 230 and the rotor 250 in the rotating electrical machine shown in FIG. 4 and corresponds to one magnetic pole.

FIG. 7 is an enlarged view of a portion near an inter-magnet bridge section 260 of the rotating electrical machine shown in FIG. 6.

FIG. 8 is a view for showing stress distribution during high-speed rotation of the rotating electrical machine shown in FIG. 6 by using constant stress lines, and corresponds to a half magnetic pole, that is, a half of the one magnetic pole of the rotor.

FIG. 9 is a view for showing distribution of magnetic flux lines when a stator winding 238 is not energized with three-phase AC power, and corresponds to the one magnetic pole of the embodiment of the rotating electrical machine according to the invention shown in FIG. 6.

FIG. 10 is a view for further enlarging a corner of a permanent magnet 254 and a corner of a magnet insertion hole 253 on a periphery thereof, and corresponds to the one magnetic pole of the embodiment of the rotating electrical machine according to the invention shown in FIG. 6 or FIG. 7. (a) shows an example in which an inner surface of the corner of the magnet insertion hole 253 that faces closest to the corner of the permanent magnet 254 is formed in a substantially arcuate curved surface and in which each of radial and circumferential inner surfaces thereof connected to the arcuate curved surface is a planar surface. (b) shows an example in which the inner surface of the corner of the magnet insertion hole 253 that faces closest to the corner of the permanent magnet 254 is formed in a planar curved surface and in which each of the radial and circumferential inner surfaces thereof connected to the planar curved surface is a substantially arcuate curved surface.

FIG. 11 shows a modification example of the embodiment of the rotating electrical machine according to the invention and is an enlarged cross-sectional view of the stator 230 and the rotor 250 that correspond to the one magnetic pole in a configuration that the three permanent magnets are provided for each magnet pole and that the inter-magnet bridge section 260 is provided between the adjacent magnets.

FIG. 12 shows another modification example of the embodiment of the rotating electrical machine according to the invention and is an enlarged cross-sectional view of the stator 230 and the rotor 250 that correspond to the one magnetic pole in a configuration that is provided with the two magnetic insertion holes for each magnetic pole, in which the two permanent magnets are inserted in each magnetic insertion hole, and the inter-magnet bridge section 260 between the two magnet insertion holes.

FIG. 13 shows yet another modification example of the embodiment of the rotating electrical machine according to the invention and is an enlarged cross-sectional view of the stator 230 and the rotor 250 that correspond to the one magnetic pole in a configuration in which the two permanent magnets 254 for the one magnetic pole are arranged in a V shape.

FIG. 14 shows a second embodiment of the rotating electrical machine according to the invention and is an enlarged view of one fourth of the overall cross sections of the stator 231 and the rotor 251 in the rotating electrical machine having the eight poles and 12 slots that is configured by the rotor of the first embodiment shown in FIG. 4 and the concentrated winding stator having the 12 poles.

### DESCRIPTION OF EMBODIMENTS

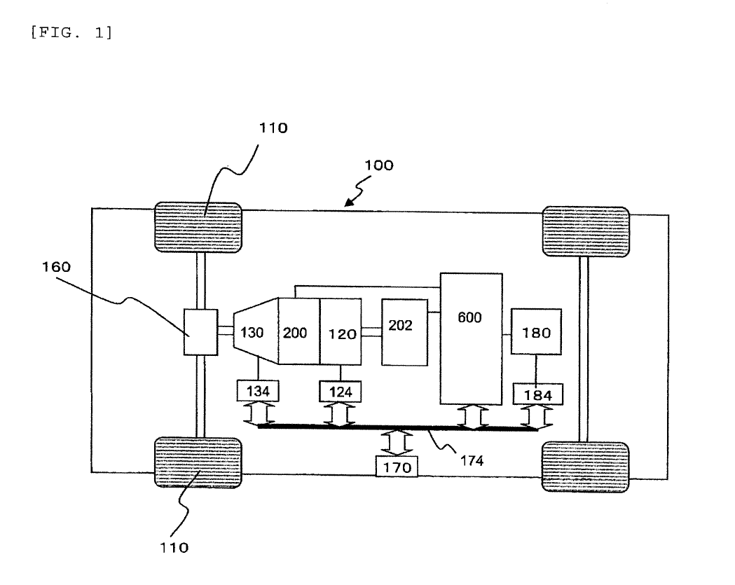

Embodiments for carrying out the invention will hereinafter be described with reference to FIG. 1 to FIG. 14.

A rotating electrical machine according to the invention can output high power as will be described below, and thus is suitable as a traveling motor for an electric vehicle, for example. The rotating electrical machine according to the invention can be applied to an electric vehicle that travels exclusively by the rotating electrical machine and to a hybrid electric vehicle that is driven by both of an engine and the rotating electrical machine. A description will hereinafter be made on an example using the hybrid electric vehicle.

FIG. 1 is a schematic configuration diagram of a hybrid electric vehicle in which a rotating electrical machine according to an embodiment of the invention is mounted. An engine 120, a first rotating electrical machine 200, a second rotating electrical machine 202, and a battery 180 are mounted in a vehicle 100. The battery 180 supplies DC power to the rotating electrical machines 200, 202 via a power converter 600 when driving forces generated by the rotating electrical machines 200, 202 are necessary. The battery 180 is charged by converting AC power of the DC power from the rotating electrical machines 200, 202 to the DC power when the vehicle travels in a regeneration state. The DC power is supplied and received between the battery 180 and the rotating electrical machines 200, 202 via the power converter 600. In addition, although not shown, a battery for supplying low voltage power (such as 14 volt power) is mounted in the vehicle to supply the DC power to a control circuit, which will be described below.

Rotational torque generated by the engine 120 and the rotating electrical machines 200, 202 is transferred to front wheels 110 via a transmission 130 and a differential gear 160. The transmission 130 is controlled by a transmission control device 134, and the engine 120 is controlled by an engine control device 124. The battery 180 is controlled by a battery control device 184. The transmission control device 134, the engine control device 124, the battery control device 184, the power converter 600, and an integrated control device 170 are connected by a communication line 174.

The integrated control device 170 is a control device that is superordinate to the transmission control device 134, the engine control device 124, the power converter 600, and the battery control device 184, and receives information indicative of a state of each of the transmission control device 134, the engine control device 124, the power converter 600, and the battery control device 184 therefrom via the communication line 174. The integrated control device 170 generates a control command for each control device on the basis of the acquired information. The thus-generated control command is sent to each control device via the communication line 174.

The high-voltage battery 180 is configured by a secondary battery such as a lithium ion battery or a nickel hydrogen battery, and outputs the high voltage DC power of 250 volts to 600 volts or higher. The battery control device 184 outputs a charging/discharging condition of the battery 180 and a state of each unit cell battery that constitutes the battery 180 to the integrated control device 170 via the communication line 174.

The integrated control device 170 outputs a command of a power generation operation to the power converter 600 when determining on the basis of the information from the battery control device 184 that the battery 180 needs to be charged. In addition, the integrated control device 170 mainly manages output torque of the engine 120 and the rotating electrical machines 200, 202, arithmetically processes total torque of and a torque distribution ratio of the output torque of the engine 120 and the output torque of the rotating electrical machines 200, 202, and sends the control command that is based on a result of the arithmetic processing to the transmission control device 134, the engine control device 124, and the power converter 600. Based on a torque command from the integrated control device 170, the power converter 600 controls the rotating electrical machines 200, 202 to make them produce commanded torque output or generated power.

The power converter 600 is provided with a power semiconductor that constitutes an inverter for operating the rotating electrical machines 200, 202. The power converter 600 controls a switching operation of the power semiconductor on the basis of the command from the integrated control device 170. The rotating electrical machines 200, 202 are each operated as an electric motor or a generator by the switching operation of the power semiconductor.

When the rotating electrical machines 200, 202 are operated as the electric motors, the DC power from the high-voltage battery 180 is supplied to a DC terminal of the inverter in the power converter 600. The power converter 600 converts the DC power, which has been supplied thereto by controlling the switching operation of the power semiconductor, to three-phase AC power and supplies it to the rotating electrical machines 200, 202. Meanwhile, when the rotating electrical machines 200, 202 are operated as the generators, rotors in the rotating electrical machines 200, 202 are rotationally driven by rotational torque applied thereto from the outside, and the three-phase AC power is generated in stator windings in the rotating electrical machines 200, 202. The thus-generated three-phase AC power is converted to the DC power by the power converter 600, and the DC power is supplied to the high-voltage battery 180 to charge the battery 180.

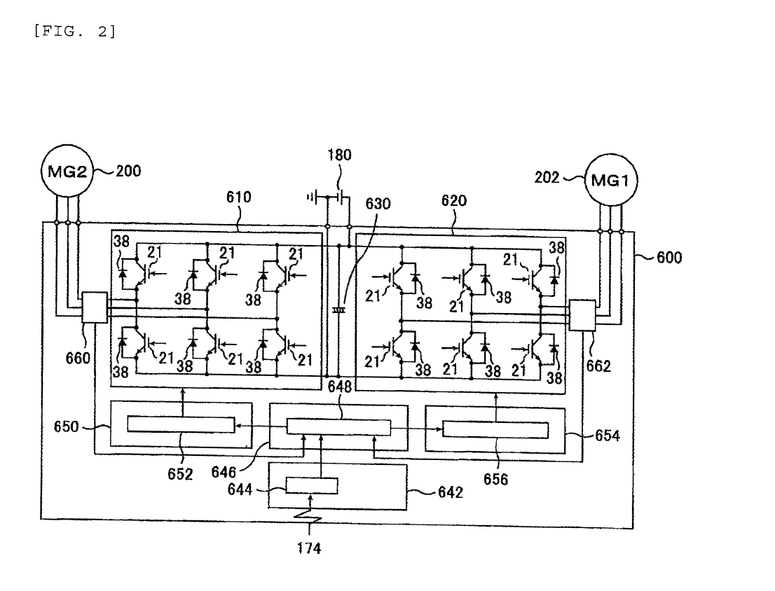

FIG. 2 is a circuit diagram of the power converter 600 in FIG. 1. The power converter 600 is provided with a first inverter device for the rotating electrical machine 200 and a second inverter device for the rotating electrical machine 202. The first inverter device includes a power module 610, a first drive circuit 652 for controlling the switching operation of each of power semiconductors 21 in the power module 610, and a current sensor 660 for detecting a current in the rotating electrical machine 200. The drive circuit 652 is provided on a drive circuit board 650.

Meanwhile, the second inverter device includes a power module 620, a second drive circuit 656 for controlling the switching operation of each power semiconductor 21 in the power module 620, and a current sensor 662 for detecting a current in the rotating electrical machine 202. The drive circuit 656 is provided on a drive circuit board 654. A control circuit 648 that is provided on a control circuit board 646, a capacitor module 630, and a transceiver circuit 644 that is mounted on a connector board 642 are shared and used by the first inverter device and the second inverter device.

The power modules 610, 620 are operated by drive signals that are output from the respectively corresponding drive circuits 652, 656. The power modules 610, 620 convert the DC power supplied from the battery 180 to the three-phase AC power and supply the power to the stator windings that are armature windings of the respectively corresponding rotating electrical machines 200, 202. In addition, the power modules 610, 620 respectively convert the AC power that is induced to the stator windings of the rotating electrical machines 200, 202 to the DC power and supply it to the high-voltage battery 180.

As illustrated in FIG. 2, the power modules 610, 620 each includes a three-phase bridge circuit, and series circuits, each of which corresponds to the three phases, are electrically connected in parallel between a positive electrode side and a negative electrode side of the battery 180. Each of the series circuits includes the power semiconductor 21 for constituting an upper arm and the power semiconductor 21 for constituting a lower arm, and these power semiconductors 21 are connected in series. As shown in FIG. 2, the power module 610 and the power module 620 have a substantially same circuit configuration, and a description will be made here on the power module 610 as a representative example.

In this embodiment, an insulated gate bipolar transistor (IGBT) 21 is used as a switching power semiconductor element. The IGBT 21 includes three electrodes, namely, a collector electrode, an emitter electrode, and a gate electrode. A diode 38 is electrically connected between the collector electrode and the emitter electrode of the IGBT 21. The diode 38 includes two electrodes, namely, a cathode electrode and an anode electrode. The cathode electrode and the anode electrode are electrically connected to the collector electrode of the IGBT 21 and the emitter electrode of the IGBT 21, respectively, such that a direction from the emitter electrode to the collector electrode of the IGBT 21 is set as a forward direction.

A metal-oxide-semiconductor field-effect transistor (MOSFET) may be used as the switching power semiconductor element. The MOSFET includes three electrodes, namely, a drain electrode, a source electrode, and a gate electrode. Because the MOSFET includes a parasitic diode between the source electrode and the drain electrode with a direction from the drain electrode to the source electrode being set as the forward direction, the diode 38 in FIG. 2 does not have to be provided.

The arms in each phase are configured such that the emitter electrode of the IGBT 21 is electrically connected in series with the collector electrode of the IGBT 21. In this embodiment, the only one IGBT is shown for each of the upper and lower arms in each phase; however, the plural IGBTs are actually and electrically connected in parallel because a current capacity to be controlled is large. The plural IGBTs will hereinafter be described as one power semiconductor for the purpose of a simple description.

In the example shown in FIG. 2, each of the upper and lower arms in each phase includes the three IGBTs. The collector electrode of each IGBT 21 in the upper arm of each phase is electrically connected to the positive electrode side of the battery 180, and the source electrode of each IGBT 21 in the lower arm of each phase is electrically connected to the negative electrode side of the battery 180. A middle point between the arms in each phase (a connected portion between the emitter electrode of the IGBT on the upper arm side and the collector electrode of the IGBT on the lower arm side) is electrically connected to the armature winding (stator winding) of the corresponding phase in corresponding one of the rotating electrical machines 200, 202.

Each of the drive circuits 652, 656 constitutes a drive section for controlling the corresponding one of the inverter devices 610, 620, and generates a drive signal for driving the IGBT 21 on the basis of a control signal output from the control circuit 648. The drive signal that is generated in each of the drive circuits 652, 656 is output to the gate of each power semiconductor element in the corresponding one of the power modules 610, 620. Each of the drive circuits 652, 656 is provided with six integrated circuits, each of which generates a drive signal supplied to the gate of each of the upper and lower arms in each phase. The six integrated circuits constitute one block.

The control circuit 648 constitutes a control section for each of the inverter devices 610, 620, and is configured by a microcomputer that generates the control signal (a control value) for operating (turning ON/OFF) the plural switching power semiconductor elements. The control circuit 648 receives a torque command signal (torque command value) from the superordinate control device, sensor output from each of the current sensors 660, 662, and sensor output from a rotation sensor that is mounted in each of the rotating electrical machines 200, 202. The control circuit 648 calculates the control value on the basis of these input signals, and outputs the control signal for controlling switching timing to the drive circuits 652, 656.

The transceiver circuit 644, which is mounted on the connector board 642, is used to electrically connect the power converter 600 to the external control device, and transmits/receives information to/from another device via the communication line 174 in FIG. 1. The capacitor module 630 constitutes a smoothing circuit for suppressing fluctuation in a DC voltage that is caused by the switching operation of the IGBT 21, and is electrically connected to a DC terminal in parallel in each of the first power module 610 and the second power module 620.

### <Embodiments of the Rotating Electrical Machine According to the Invention>

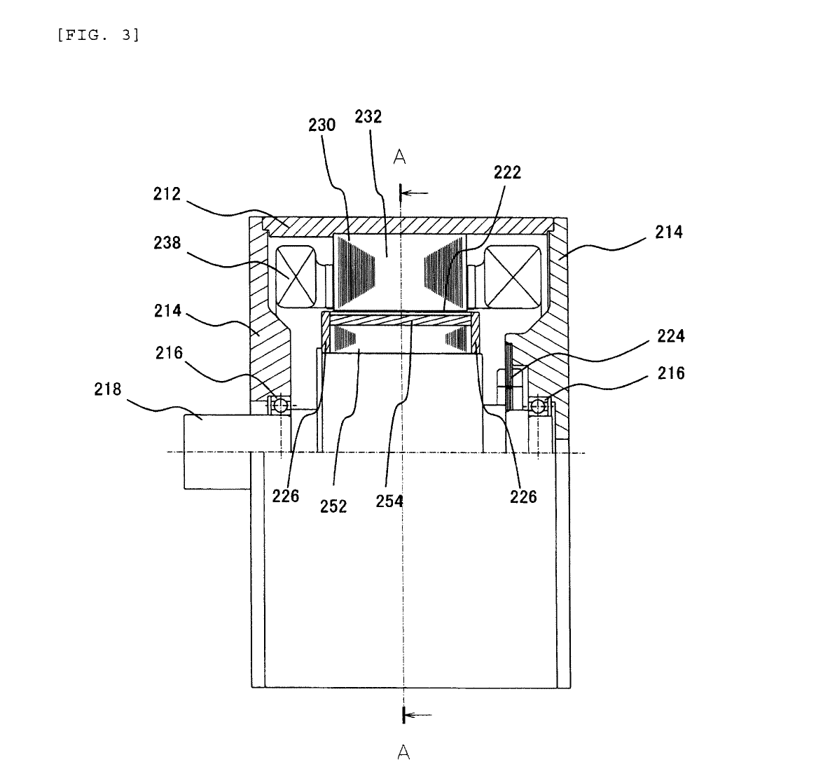

FIG. 3 is a cross-sectional view of an embodiment of the rotating electrical machine according to the invention that is used as the rotating electrical machine 200 in FIG. 1. The rotating electrical machine 200 and the rotating electrical machine 202 have a substantially same structure, and the structure of the rotating electrical machine 200 will hereinafter be described as a representative example. It should be noted that the structure, which will be described below, does not have to be adopted for both of the rotating electrical machines 200, 202 but may be adopted for one of the rotating electrical machines 200, 202.

A stator 230 is supported in a housing 212, and the stator 230 includes a stator core 232 and a stator winding 238. A rotor 250 is rotatably supported on an inner peripheral side of the stator core 232 via a gap 222. The rotor 250 includes a rotor core 252 that is fixed to a shaft 218, a permanent magnet 254, and an abutment plate 226 formed of a nonmagnetic body. The housing 212 has paired end brackets 214, each of which is provided with a bearing 216, and the shaft 218 is rotatably supported by these bearings 216.

The shaft 218 is provided with a resolver 224 for detecting a position of a pole and a rotational speed of the rotor 250. The control circuit 648, which is shown in FIG. 2, receives output from the resolver 224. The control circuit 648 outputs the control signal to the drive circuit 652 on the basis of the received output. The drive circuit 652 outputs the drive signal that is based on the control signal to the power module 610. The power module 610 performs the switching operation on the basis of the control signal, and converts the DC power supplied from the battery 180 to the three-phase AC power. The three-phase AC power is supplied to the stator winding 238, which is shown in FIG. 3, and a rotating magnetic field is thereby generated in the stator 230. A frequency of a three-phase AC current is controlled on the basis of an output value of the resolver 224, and a phase of the three-phase AC current with respect to a rotational position of the rotor 250 is also controlled on the basis of the output value of the resolver 224.

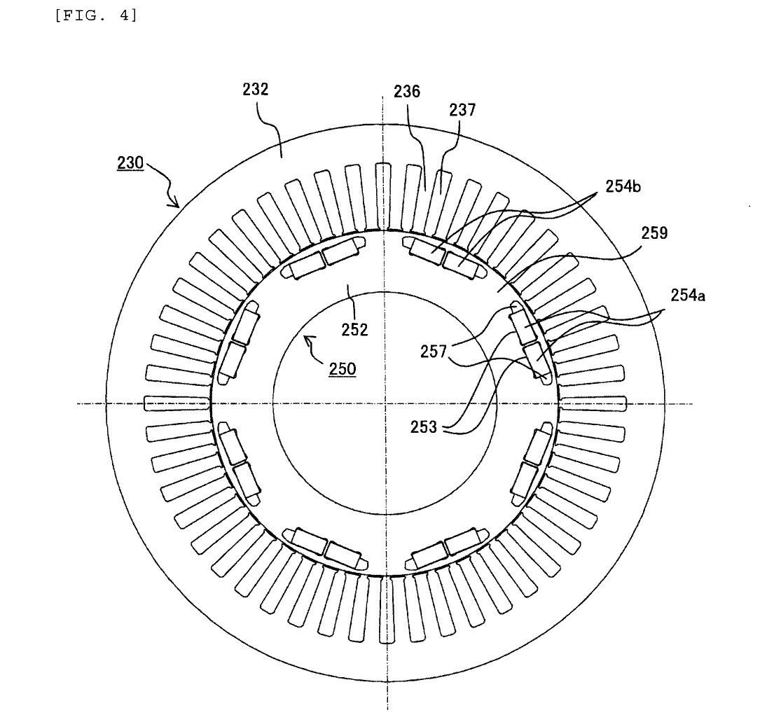

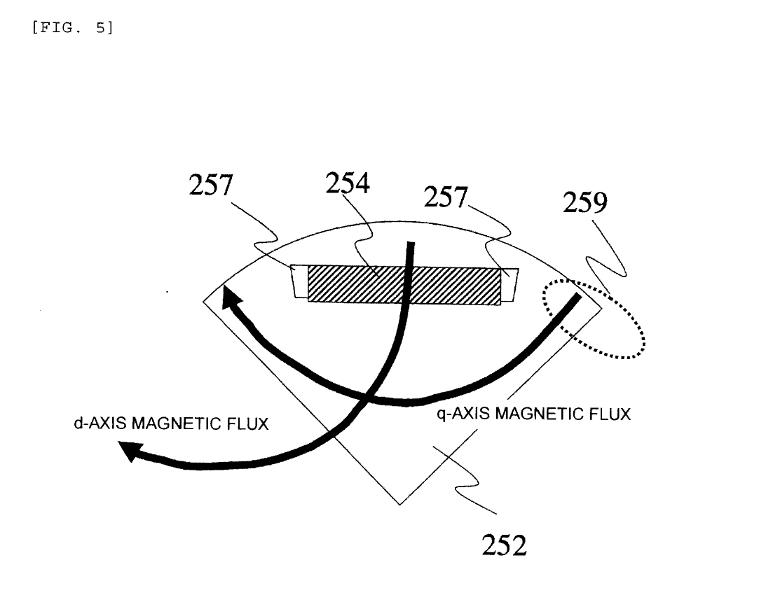

FIG. 4 is a view for showing cross sections of the stator 230 and the rotor 250 shown in FIG. 3 and is also a cross-sectional view taken along the line A-A of FIG. 3. The housing 212, the shaft 218, and the stator winding 238 are not shown in FIG. 4. The stator winding in a slot 237 is not shown in FIG. 5 onward.

A number of the slots 237 and a number of teeth 236 are disposed over an entire inner periphery of the stator core 232 at equal intervals. In FIG. 4, not all of the slots and the teeth are denoted by the reference numerals, but only parts thereof are denoted by the reference numerals. A slot insulation material (not shown) is provided in the slot 237 and is wound by a plurality of U-phase, V-phase, and W-phase windings that constitute the stator winding 238 in FIG. 3. In this embodiment, the 48 slots 237 are formed at the equally spaced intervals.

A vicinity of an outer periphery of a rotor core 252 is arranged with 16 magnet insertion holes 253, in each of which a rectangular magnet is inserted, along a circumferential direction. Each magnet insertion hole 253 is formed along an axial direction, and the permanent magnet 254 (254a, 254b) is embedded and fixed by an adhesive or the like in the magnet insertion hole 253. The paired magnet insertion holes 253 and the paired permanent magnet 254 respectively form a magnetic pole. Each pair of the magnet insertion holes 253 is set to have a wider circumferential width than each pair of the permanent magnets 254, and a hole space 257 on the outside of the magnetic pole of the permanent magnet 254 functions as a magnetic gap. The hole space 257 may be filled with the adhesive or hardened by a molding resin so as to be integrated with the permanent magnet 254. The permanent magnet 254 acts as a field magnetic pole of the rotor 250, and this embodiment is configured to have the eight poles.

A magnetization direction of the permanent magnet 254 is set as a radial direction, and the magnetization direction is reversed by every field pole. In other words, if a surface of the permanent magnet 254a on the stator side is an N pole and a surface thereof on the axial side is an S pole, a surface of the permanent magnet 254b on the stator side is the S pole and a surface thereof on the axial side is the N pole. The paired permanent magnets 254a and the paired permanent magnets 254b respectively form the one magnetic pole and are alternatively arranged in the circumferential direction.

The permanent magnet 254 may be inserted in the magnet insertion hole 253 after being magnetized or may be magnetized by being applied with a strong magnetic field after being inserted in the magnet insertion hole 253 of the rotor core 252. The permanent magnet 254 becomes a strong magnet after being magnetized. Thus, if a magnet is polarized before the permanent magnet 254 is fixed to the rotor 250, a strong suction force is generated between the rotor core 252 and the permanent magnet 254 during fixation of the permanent magnet 254, thereby disturbing assembly work. In addition, the strong suction force of the permanent magnet 254 may lead to adhesion of dust such as iron powder to the permanent magnet 254. Therefore, in consideration of productivity of the rotating electrical machine, the permanent magnet 254 is preferably magnetized after being inserted in the rotor core 252.

As the permanent magnet 254, a neodymium-based or samarium-based sintered magnet, a ferrite magnet, a neodymium-based bond magnet, or the like may be used. Residual magnetic flux density of the permanent magnet 254 is approximately 0.4 to 1.3 T.

When the three-phase AC current flows through the stator winding 238, thereby generating the rotating magnetic field in the stator 230, the rotating magnetic field acts on the permanent magnets 254a, 254b of the rotor 250 to generate torque. The torque is expressed by a product of a component of the magnetic flux from the permanent magnet 254 that is interlinked with each winding and a component that is orthogonal to an interlinkage magnetic flux of the AC current flowing through each winding. Here, if it is considered that an AC current waveform is in a sinusoidal shape, a product of a fundamental wave component of the interlinkage magnetic flux and a fundamental wave component of the AC current becomes a time average component of the torque, and a product of a harmonic component of the interlinkage magnetic flux and the fundamental wave component of the AC current becomes a torque ripple that is a harmonic component of the torque. That is, in order to reduce the torque ripple, the harmonic component of the interlinkage magnetic flux has to be reduced. In other words, because a product of the interlinkage magnetic flux and an angular acceleration of rotation of the rotor corresponds to an induced voltage, the reduction of the harmonic component of the interlinkage magnetic flux is substantially the same as the reduction of the harmonic component of the induced voltage.

FIG. 5 is a view for explaining reluctance torque. In general, an axis of the magnetic flux that passes through the center of the magnet is referred to as a d-axis, while an axis of the magnetic flux that flows from an area between the poles of the magnets to another area between the poles is referred to as a q-axis. At this time, a core portion at the center of the area between the poles of the magnets is referred to as an auxiliary salient pole section 259. The permanent magnet 254, which is provided in the rotor 250, has substantially the same magnetic permeability as the air. Thus, when seen from the stator side, the d-axis is magnetically recessed while the q-axis is magnetically projected. Accordingly, the core portion of the q-axis is referred to as a salient pole. The reluctance torque is generated by a difference in transmittability (magnetic inductance) of the magnetic flux between the d-axis and q-axis, that is, a salient pole ratio.

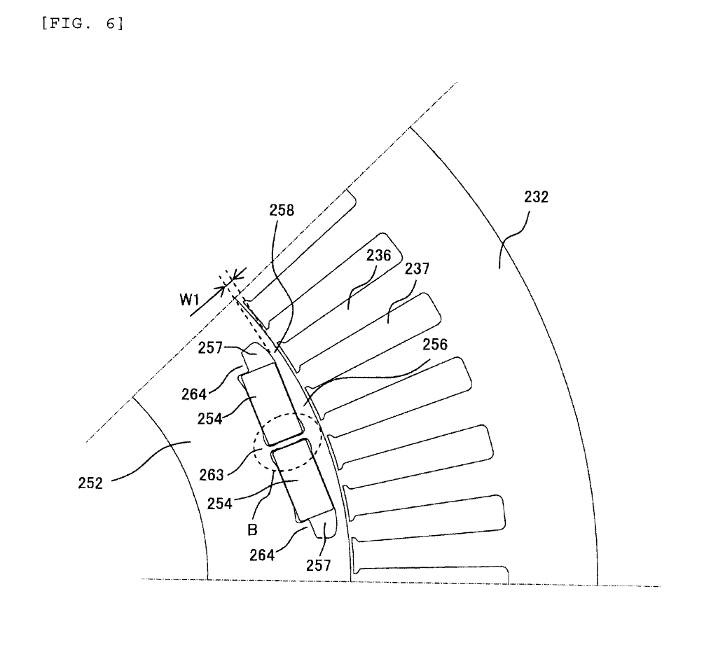

FIG. 6 is an enlarged cross-sectional view of the stator 230 and the rotor 250 in the rotating electrical machine shown in FIG. 4, and corresponds to the one magnetic pole. The rotor core 252 is formed with the magnetic gap 257 on the outside of the magnetic pole of the permanent magnet 254 so as to reduce cogging torque or torque pulsation during energization. Furthermore, a radial thickness of the magnetic gap 257 is smaller than a radial thickness of the permanent magnet 254, and a magnetic pole end pressing section 264 that is a portion of the rotor core on an inner peripheral side of the magnetic gap 257 restricts movement of the permanent magnet 254 in the circumferential direction. Moreover, a magnetic pole outside section 256 on the outside in the radial direction of the magnet insertion holes 253, in which the permanent magnet 254 is inserted, is set such that a width W1 of a magnetic pole end bridge section 258 becomes the smallest in a radial dimension.

When the width W1 of the magnetic pole end bridge section 258 is reduced, the magnetic flux from the permanent magnet that flows through a magnetic path in the rotor is reduced, and the increased magnetic flux reaches the stator side. Thus, the magnetic torque can be increased. Accordingly, it is preferred that the width W1 of the magnetic pole end bridge section 258 is reduced as small as possible to such a degree that it can withstand stress generated during rotation of the rotor.

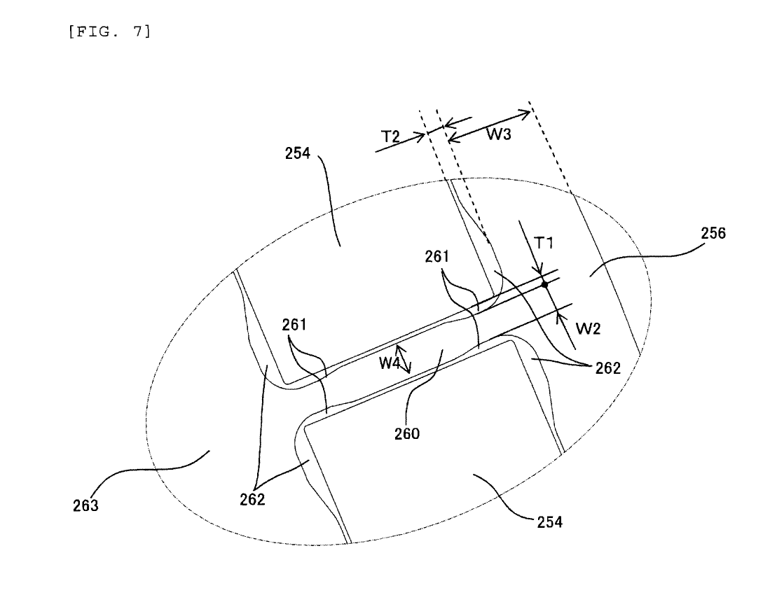

FIG. 7 is an enlarged view of an inter-magnet bridge section 260 (an area indicated by B) of the rotor shown in FIG. 6. The inter-magnet bridge section 260 is provided between the paired permanent magnets 254 such that the magnetic pole outside section 256 of the rotor core, which is positioned on the outer peripheral side of the permanent magnet 254, is mechanically connected to a magnetic pole inside section 263 of the rotor core on the inner peripheral side. Furthermore, a circumferential clearance section 261 and a radial clearance section 262 are set at each of four corners of the magnet insertion holes 253 positioned at both ends of the inter-magnet bridge section 260 such that the corner of the permanent magnet 254 does not contact the rotor core even when the magnet approaches closest to the bridge section in regard to dimensional tolerance. In such a case, a thickness T1 of the circumferential clearance section 261 is set to be reduced at the center of the permanent magnet 254 and the corner of the permanent magnet 254 and to become maximum therebetween. A thickness T2 of the radial clearance section 262 is set to be reduced at the center of the permanent magnet 254 and the corner of the permanent magnet 254 and to become maximum therebetween. Moreover, similar to the above-mentioned magnetic pole end pressing section 264 on the inner peripheral side of the magnetic gap 257, the movement of the permanent magnet 254 in the circumferential direction is restricted at the center of the inter-magnet bridge section 260. Thus, favorable assemblability can be achieved without using a new component.

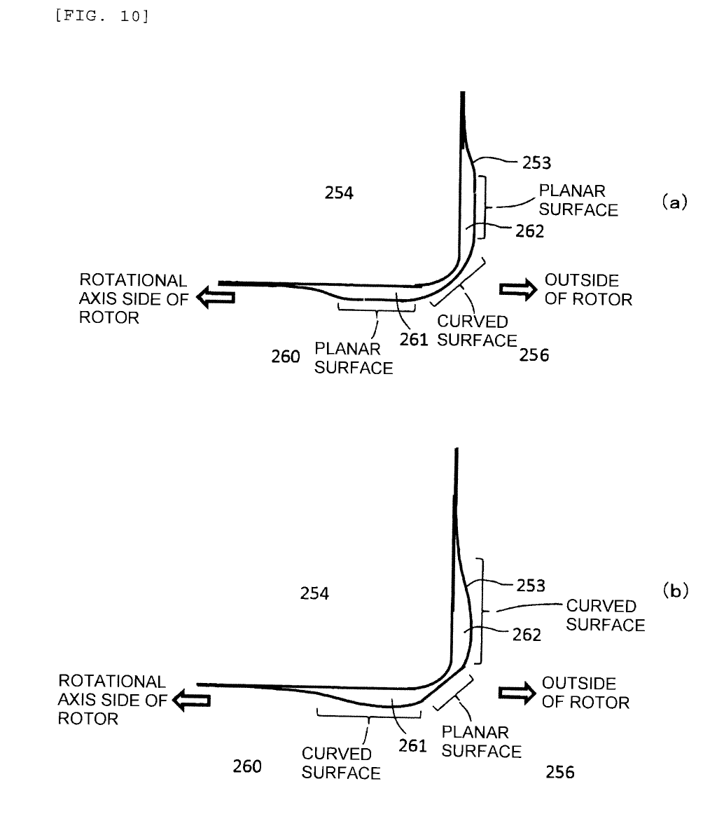

It should be noted that shapes of the above-mentioned four corners shown in FIG. 7 are described on the basis of FIG. 10(a), which will be described below.

It is possible by adopting such a configuration to prevent damage to and deformation of the rotor core 252 that is caused when the corner of the magnet contacts the rotor core and is also possible to reduce stress concentration generated on both ends of the inter-magnet bridge section 260. Accordingly, the rotor 250 can achieve high-speed rotation.

In this embodiment, a line that connects between the circumferential clearance section 261 and the radial clearance section 262 has a larger radial dimension than the corner of the magnet; however, a same effect can be obtained by combining a straight line and an arc as will be described below.

In general, when the inter-magnet bridge section 260 is provided, the magnetic flux of the permanent magnet 254 passes through the inter-magnet bridge section 260, and a magnetic flux path is closed in the rotor. Accordingly, the effective magnetic flux that is coupled with an opposed stator magnetic pole at the center of a rotor magnetic pole is reduced, thereby degrading performance. Thus, a width W2 of a narrowest portion of the inter-magnet bridge section 260 is preferably as small as possible.

In addition, a width W4 at the center of the inter-magnet bridge section 260 is set to be slightly larger than W2 as described above; however, the width W4 is also preferably as small as possible. When the width W4 at the center of the inter-magnet bridge section 260 is small, the permanent magnets that are inserted in the two adjacent magnet insertion holes 253 further approach each other, and a reduction in the magnetic flux density at the center of the magnetic pole is thereby suppressed. The rotor can be designed to satisfy such a relationship between W2 and W4 due to a structure of the rotor according to the invention.

The permanent magnet does not have to be in an exact rectangular shape but may be in a substantially rectangular shape. In this case, corresponding to a cross-sectional shape of the permanent magnet, a cross-sectional shape of the magnet insertion hole is also set to the substantially rectangular shape. When the shape of the permanent magnet is changed from the rectangular shape, distribution of the magnetic flux density can also be changed.

In this embodiment, the minimum width W1 of the magnetic pole end bridge section 258, the minimum width W2 of the inter-magnet bridge section 260, and a width W3 of the rotor core on the outer peripheral side of the radial clearance section 262 establish W2<W1<W3. This relationship among W1, W2, and W3 can be achieved by adopting the structure of the rotor that has the above-mentioned characteristic, and will be described below.

The stress generated by a centrifugal force of the rotor is increased at a root of the inter-magnet bridge section 260 on the outer peripheral side of the rotor, that is, at the corners of the two adjacent magnet insertion holes 253 on the outer peripheral side of the rotor with the inter-magnet bridge section 260 being interposed therebetween as well as on the magnetic pole end bridge section 258 side. However, in an example shown in FIG. 6, because the inter-magnet bridge section 260 that connects the magnetic pole outside section 256 and the magnetic pole inside section 263 is provided between the two permanent magnets 254 and between the two magnet insertion holes 253 in which the two permanent magnets 254 are inserted, the stress in the magnetic pole end bridge section 258 becomes the largest by the principle of leverage.

Accordingly, in order to prevent leakage of the magnetic flux, it is preferred that the magnetic pole end bridge section 258 has the reduced minimum width W1 and is brought into a magnetic saturation state from the perspective of performance only; however, due to the high stress concentration during the high-speed rotation, it requires a sufficient thickness to withstand the stress.

Although the minimum width W2 of the inter-magnet bridge section 260 is substantially the same as the minimum width W1 of the magnetic pole end bridge section 258, a degree of the stress concentration thereon is smaller than that on the magnetic pole end bridge section 258 as described above, and W2<W1 can thus be established. Meanwhile, the width W3 of the rotor core on the outer peripheral side of the radial clearance section 262 serves as a magnetic path through which the magnetic flux of the permanent magnet 254 passes when being interlinked with the each winding, and thus is desired not to be saturated. Accordingly, W3>W1 is established.

As described above, the width W4 at the center of the inter-magnet bridge section 260 can be set slightly smaller than W2 due to the structure of the rotor according to the invention. In other words, W4<W1<W3 is established. Due to such a structure, a distance between the two adjacent permanent magnets can be reduced, and the magnetic flux density at the center of the rotor magnetic pole can be maintained to be high.

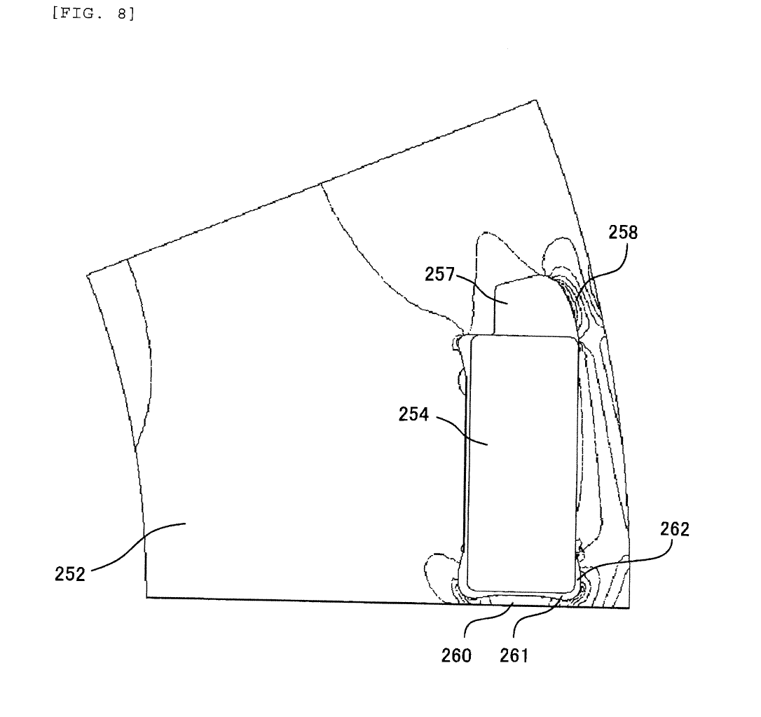

FIG. 8 is a half magnetic pole model for showing the stress distribution during the high-speed rotation of the rotating electrical machine shown in FIG. 6 by using constant stress lines, and corresponds to a half magnetic pole, that is, a half of the one magnetic pole of the rotor. The stress is concentrated on the magnetic pole end bridge section 258 and both ends of the inter-magnet bridge section 260 where the constant stress lines are concentrated in comparison with other portions. However, because it is configured that W2<W1<W3 is established as described above, the stress is dispersed without being locally concentrated on the magnetic pole end bridge section 258 and both ends of the inter-magnet bridge section 260.

In the above-mentioned embodiment of the rotating electrical machine according to the invention, the two permanent magnets 254 that correspond to the one magnetic pole are linearly aligned. Accordingly, the stress generated at both ends of the inter-magnet bridge section 260 can substantially be equalized, and the stress concentration thereon can also be avoided. Thus, even when the permanent magnets 254 are not linearly aligned, an effect of the invention can be obtained despite a fact that such alignment is preferred in terms of strength.

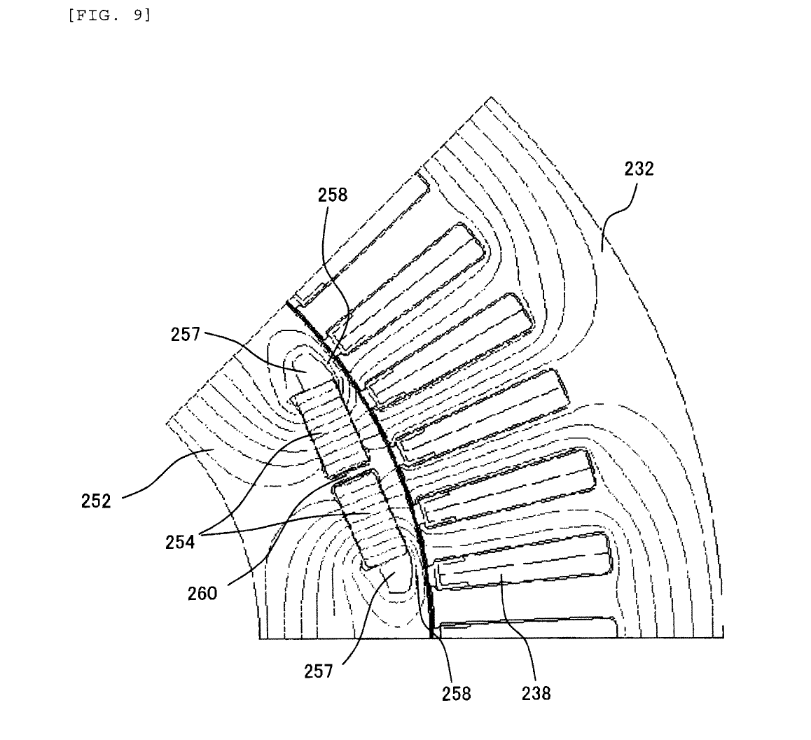

FIG. 9 shows distribution of the magnetic flux lines when the stator winding 238 is not energized with the three-phase AC power, and corresponds to the one magnetic pole of the embodiment of the rotating electrical machine according to the invention shown in FIG. 6. As described above, it is configured that dimensions of W1, W2, and W3 are set to establish the relationship of W2<W1<W3. It can be understood from such a configuration that the magnetic pole end bridge section 258 and the inter-magnet bridge section 260 are saturated by the minimum magnetic flux of the magnetic flux generated from the permanent magnet 254 and that a majority of the magnetic flux is coupled with the stator core 232 from the magnetic pole outside section 263 of the rotor core and is interlinked with the stator winding 238.

FIG. 10 is an enlarged view of the one corner of the permanent magnet 254 and a portion of the magnet insertion hole 253 on the periphery thereof that are shown in FIG. 7 or FIG. 8. The four corners of the two magnet insertion holes 253 that hold the inter-magnet bridge section 260 therebetween have the same shape, and, of the four corners, an enlarged lower right portion of the permanent magnet 254 in FIG. 8 is particularly shown as a representative example.

The corner of the permanent magnet is chamfered in a curved shape or a planar shape to such a degree that the shape has no influence on a magnetic characteristic. FIG. 10 shows an example in which the corner of the permanent magnet is in the curved shape. Due to such a shape of the corner, an inner surface of the corner of the magnet insertion hole that faces the corner can have a gentle curve, and the stress generated by the rotation of the rotor can thereby be dispersed.

In addition, as shown in FIG. 10, because the curvature of the inner surface of the corner of the magnet insertion hole is partially configured by linear and curved lines, a difference between the maximum width W4 of the inter-magnet bridge section and the minimum width W2 of the inter-magnet bridge section in the circumferential clearance section 261 is reduced, and W2 and W4 can have small values.

In an example shown in FIG. 10(a), a portion of the inner surface of the corner of the magnet insertion hole 253 that is positioned closest to the corner of the permanent magnet 254 has a curved surface (shown in the curved shape in the drawing) that is gentler than the curved shape of the corner of the permanent magnet 254, and inner surfaces of the circumferential clearance section 261 and the radial clearance section 262 that connect to the portion are each configured by a planar surface (shown by the linear line in the drawing). It should be noted that, in FIG. 7, which is described above, the shape of the inner surface of the corner of the magnet insertion hole 253 is shown on the basis of FIG. 10(a).

In FIG. 10(b), the portion of the inner surface of the corner of the magnet insertion hole 253 that is positioned closest to the corner of the permanent magnet 254 is in the planar shape (shown by the linear line in the drawing), and the inner surfaces of the circumferential clearance section 261 and the radial clearance section 262 that connect to the portion are each configured by a substantially arcuate curved surface (shown by the curved line in the drawing).

In a case where the corner of the permanent magnet 254 is chamfered in the planar surface and where the corner of the magnet insertion hole 253 that faces the corner of the permanent magnet 254 has the planar surface, the planar surface of the corner of the magnet insertion hole 253 is adapted to have the larger width than the planar surface of the corner of the permanent magnet 254.

Similarly, in a case where the corner of the permanent magnet 254 is chamfered in the curved surface and where the corner of the magnet insertion hole 253 that faces the corner of the permanent magnet 254 has the curved surface, the curved surface of the corner of the magnet insertion hole 253 is adapted to have the larger width than the curved surface of the corner of the permanent magnet 254, and curvature of the curved surface of the corner of the magnet insertion hole 253 is adapted to be smaller than curvature of the curved surface of the corner of the permanent magnet 254.

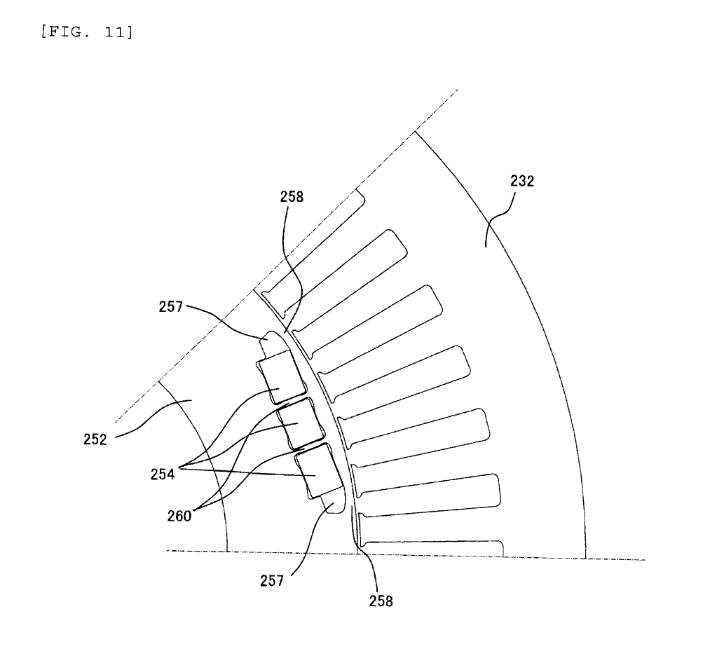

FIG. 11 shows a modification example of the rotating electrical machine according to the invention and is an enlarged cross-sectional view of the stator 230 and the rotor 250 that correspond to the one magnetic pole in a configuration that the three permanent magnets are provided for each magnet pole and that the inter-magnet bridge section 260 is provided between the two adjacent magnet insertion holes, in each of which the magnet is inserted. Even when the invention adopts the configuration in which the plural permanent magnets are provided for each magnet pole and the inter-magnet bridge section 260 is provided between the adjacent permanent magnets, that is, the configuration in which the plural inter-magnet bridge sections 260 are provided for each magnet pole, the stress during the high-speed rotation can be reduced. When the plural inter-magnet bridge sections 260 are provided for the one magnetic pole, a portion of the rotor core on the outside of the permanent magnet is firmly connected to a portion of the rotor core on a rotational axis side of the permanent magnet. Accordingly, the further higher-speed rotation can be expected.

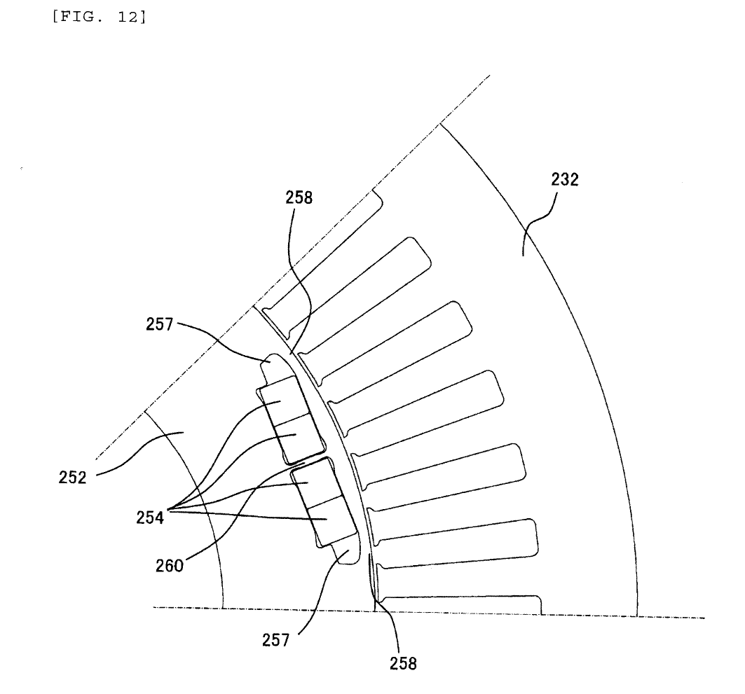

FIG. 12 is an enlarged view of the stator 230 and the rotor 250, and corresponds to the one magnetic pole in another modification example of the rotating electrical machine according to the invention. In this modification example, the two magnet insertion holes 253 are provided for each magnetic pole, and the two permanent magnets 254 are inserted in each magnet insertion hole 253. Even when the plural permanent magnets 254 are provided for the one magnet pole, there is no necessity of providing the inter-magnet bridge section 260 between every adjacent ones of the magnets as long as the stress generated during the high-speed rotation does not exceed allowable stress. In addition, eddy current that flows through a surface of the permanent magnet 254 can be reduced by dividing the permanent magnet 254 into the plural number thereof, thereby capable of reducing heat generation and improving efficiency. Accordingly, although the permanent magnet that is divided into two is inserted in the one magnet insertion hole in FIG. 12, the permanent magnet that is divided into three or more may be inserted therein.

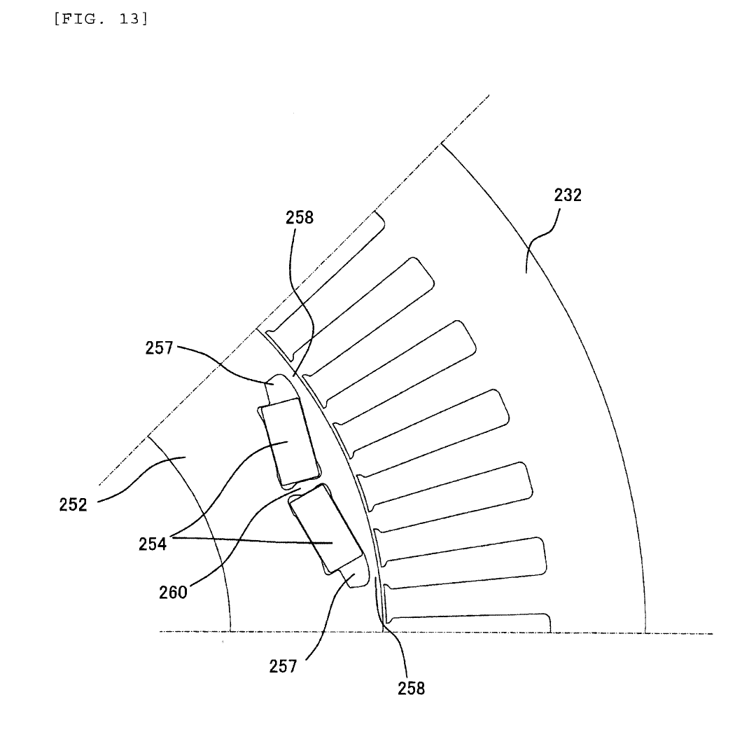

FIG. 13 shows yet another modification example of the rotating electrical machine according to the invention. This drawing also shows the enlarged stator 230 and the enlarged rotor 250 that correspond to the one magnetic pole. Even when the plural permanent magnets 254 are not aligned linearly as described above but aligned in a V shape, as similar to the abovementioned embodiment, the rotating electrical machine capable of the high-speed rotation and high power output can be realized by adopting the abovementioned structure of the rotating electrical machine according to the invention.

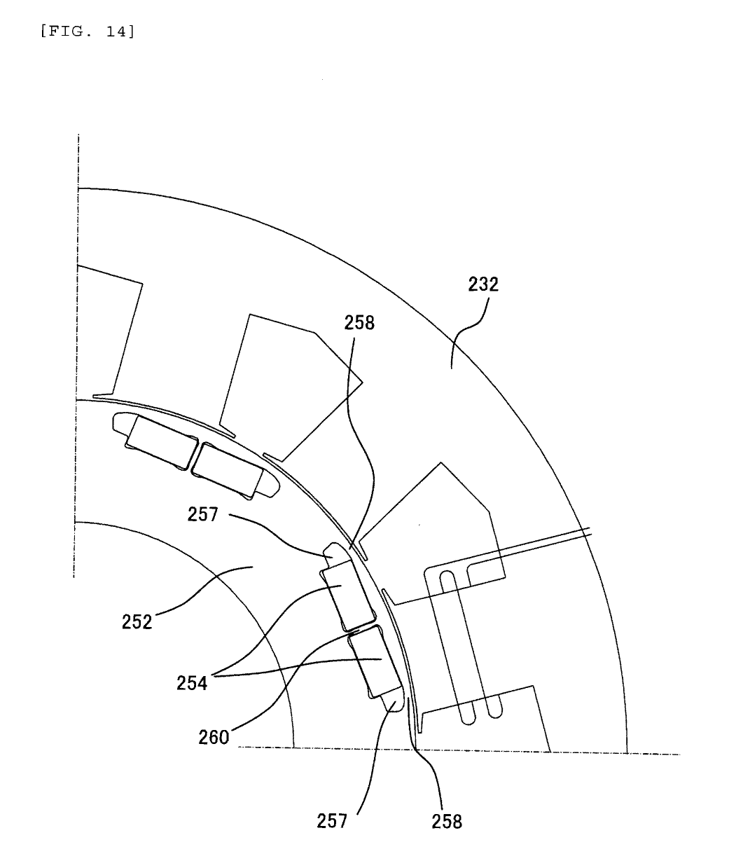

FIG. 14 shows a second embodiment of the rotating electrical machine according to the invention and shows the rotating electrical machine having eight poles and 12 slots that is configured by the rotor of the first embodiment shown in FIG. 4 and a concentrated winding stator 231 having 12 poles. The drawing shows one fourth of each of the enlarged cross sections of the stator 231 and the rotor 250. Even when the stator 230 is concentrically wound, the structure of the rotor in the rotating electrical machine according to the invention can be adopted; therefore, the same effect can be obtained by the rotating electrical machine having the concentrated winding stator. In other words, the invention does not depend on a mode of the stator.

The examples of the invention have been described so far; however, the invention is not limited to these embodiments and modification examples. A person skilled in the art can implement various modifications without compromising the characteristics of the invention. Particularly, various combinations are possible between the number of the two or more magnet insertion holes described above and the number of the permanent magnet inserted in each magnet insertion hole, and such a combination is appropriately determined in accordance with a specification of the rotating electrical machine.

The disclosure of the following basic application entitled to claim priority is incorporated herein by reference in its entirety.

Japanese Patent Application No. 2011-220056 (filed on Oct. 4, 2011)

1. A permanent magnet type rotating electrical machine having a stator and a rotor that is disposed correspondingly to the stator via a gap, wherein
the rotor includes: a rotor core having plural magnet insertion holes, each having a substantially rectangular cross section, for each magnetic pole; and a permanent magnet inserted in each of the magnet insertion holes,
a nonmagnetic section is formed at both ends in a circumferential direction of each of the plural magnet insertion holes that are provided for each magnet pole of the rotor,
a bridge section for mechanically connecting a rotor core section on the outside of the magnet insertion hole to a rotor core section on the inside of the magnet insertion hole is provided between the adjacent ones of the plural magnet insertion holes,
clearance sections that are respectively projected to the circumferential direction and a radial direction of the rotor are provided at a first corner that is a corner between a surface of the magnet insertion hole on the bridge section side and a surface of the magnet insertion hole on the outside of the rotor and at a second corner that is a corner between the surface of the magnet insertion hole on the bridge section side and a surface of the magnet insertion hole on the inside of the rotor such that a corner of the long permanent magnet with a rectangular cross section that is inserted in the magnet insertion hole does not contact the surfaces of the magnet insertion hole on the bridge section side, on the outside of the rotor, and on the inside of the rotor, and
the clearance section for the surface of the magnet insertion hole on the bridge section side is formed to reduce size thereof at the corner of the permanent magnet, while the clearance sections for the surface of the magnet insertion hole on the outside of the rotor and for the surface of the magnet insertion hole on the inside of the rotor are each formed to reduce the size thereof at the corner of the permanent magnet.

2. The permanent magnet type rotating electrical machine according to claim 1, wherein
when a minimum width of the rotor core on an outer peripheral side of the nonmagnetic section is set to W1, a minimum width of the bridge section is set to W2, and a minimum width of a core on the outer peripheral side of the rotor at the first corner of the magnet insertion hole is set to W3, the following is established:
W2<W1<W3.

3. The permanent magnet type rotating electrical machine according to claim 2, wherein
when a maximum width of the bridge section is set to W4, the following is established:
W2<W4<W1<W3.

4. The permanent magnet type rotating electrical machine according to claim 1, wherein
the corner of the permanent magnet is chamfered in a curved shape or a planar shape, and
each of the first corner of the magnet insertion hole and the second corner of the magnet insertion hole includes a curved surface that is positioned close to the corner of the permanent magnet, a planar surface that is connected to the curved surface and forms the circumferential clearance section, and a planar surface that is connected to the curved surface and forms the radial clearance section.

5. The permanent magnet type rotating electrical machine according to claim 1, wherein
the corner of the permanent magnet is chamfered in a curved shape or a planar shape, and
each of the first corner of the magnet insertion hole and the second corner of the magnet insertion hole includes a planar surface that is positioned close to the corner of the permanent magnet, a curved surface that is connected to the planar surface and forms the circumferential clearance section, and a curved surface that is connected to the planar surface and forms the radial clearance section.

6. The permanent magnet type rotating electrical machine according to claim 4, wherein
curvature of the curved surface is smaller than curvature of chamfering of a curved shape of the permanent magnet.

7. An electric driving device for a vehicle comprising:
the permanent magnet type rotating electrical machine according to claim 1, and
a power converter for supplying power to drive the electrical machine.

8. A vehicle comprising the electric driving device for a vehicle according to claim 7.
